(19) United States
(12) Patent Application Publication
(10) Pub. No.: US 2024/0367985 A1
(43) Pub. Date: Nov. 7, 2024

(54) Anode Active Material for Lithium Secondary Battery and Lithium Secondary Battery Including the Same

(71) Applicants: SK On Co., Ltd., Seoul (KR); SK Innovation Co., Ltd., Seoul (KR)

(72) Inventors: Joon Hyung MOON, Daejeon (KR); Eun Hyo KIM, Daejeon (KR); Dong Jae CHUNG, Daejeon (KR); Ju Ho CHUNG, Daejeon (KR)

(21) Appl. No.: 18/641,628

(22) Filed: Apr. 22, 2024

(30) Foreign Application Priority Data
May 4, 2023 (KR) 10-2023-0058371

(51) Int. Cl. C01B 33/32; H01M 4/133; H01M 4/134; H01M 10/052

(52) U.S. Cl. CPC C01B 33/32; H01M 4/133; H01M 4/134; H01M 10/052; C01P 2002/60; C01P 2002/72; C01P 2006/40

(57) ABSTRACT

An anode active material for a lithium secondary battery includes a lithium-silicon oxide particle that includes Li₂SiO₃ and silicon, and optionally further includes Li₂Si₂O₅. A phase fraction ratio defined by Equation 1 of the lithium-silicon oxide particle is in a range from 0.55 to 1.0. Structural and chemical stability of the anode active materials for a lithium secondary battery may be improved and side reactions can be suppressed, thereby improving life-span properties.

### CROSS-REFERENCE TO RELATED APPLICATION AND CLAIM OF PRIORITY

This application claims priority to Korean Patent Application No. 10-2023-0058371 filed on May 4, 2023 in the Korean Intellectual Property Office (KIPO), the entire disclosure of which is incorporated by reference herein.

### BACKGROUND

### 1. Field

The present disclosure relates to an anode active material for a lithium secondary battery and a lithium secondary battery including the same.

### 2. Description of the Related Art

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery is being developed and applied as a power source of an eco-friendly vehicle such as an electric automobile, a hybrid vehicle, etc.

Examples of the secondary battery includes a lithium secondary battery, a nickel-cadmium battery, a nickel-hydrogen battery, etc. The lithium secondary battery is being actively developed and applied due to high operational voltage and energy density per unit weight, a high charging rate, a compact dimension, etc.

Recently, as an application range of the lithium secondary battery has been expanded, developments of a lithium secondary battery having higher capacity and power is being progressed. For example, a silicon-based material such as a silicon oxide providing higher capacity may be used as anode active material

However, the silicon oxide may cause a gas generation in an aqueous slurry state to degrade life-span properties of the lithium secondary battery.

### SUMMARY

According to an aspect of the present disclosure invention, there is provided an anode active material for a lithium secondary battery having improved initial efficiency and life-span properties.

According to an aspect of the present disclosure invention, there is provided a lithium secondary battery having improved initial efficiency and life-span properties.

An anode active material for a lithium secondary battery includes a lithium-silicon oxide particle that includes Li₂SiO₃ and silicon, and optionally further includes Li₂Si₂O₅. A phase fraction ratio defined by Equation 1 of the lithium-silicon oxide particle is in a range from 0.55 to 1.0.

$$phase fraction ratio = P ( LS ) / ( P ( L S ) + P ( Si ) ) \qquad [ Equation 1 ]$$

In Equation 1, P(LS) is a sum of a phase fraction of Li₂SiO₃ and a phase fraction of Li₂Si₂O₅ obtained by Rietveld Refinement using an X-ray diffraction (XRD) analysis, P(Si) is a phase fraction of silicon obtained by Rietveld Refinement using the XRD analysis.

In some embodiments, a crystallite size measured by the XRD analysis of Li₂SiO₃ may be 8 nm or more.

In some embodiments, the crystallite size of Li₂SiO₃ may be obtained from Equation 2.

$$L = \frac{0.9 λ}{β cos θ} \qquad [ Equation 2 ]$$

In Equation 2, L is the crystallite size (nm), A is an X-ray wavelength (nm), β is a full width at half maximum (rad) of a peak of a (111) plane of Li₂SiO₃, and θ is a diffraction angle (rad).

In some embodiments, the crystallite size of Li₂SiO₃ may be in a range from 15 nm to 18 nm.

In some embodiments, the phase fraction ratio may be in a range from 0.6 to 1.0.

In some embodiments, the lithium-silicon oxide particle may further include an amorphous carbon.

In some embodiments, a graphite-based particle that includes natural graphite and/or artificial graphite may be further included.

A lithium secondary battery includes a cathode, and an anode facing the cathode and including the above-described anode active material for a lithium secondary battery.

In a method of preparing an anode active material for a lithium secondary battery, a first firing of silicon sources is performed to obtain a silicon oxide particle. A mixed solution is obtained by adding a solvent to a mixture of the silicon oxide particle and a lithium source. The mixed solution is dried to obtain a mixed powder. A second firing of the mixed powder is performed to form a lithium-silicon oxide particle that includes Li₂SiO₃ and silicon and optionally further includes Li₂Si₂O₅. A phase fraction ratio defined by Equation 1 of the lithium-silicon oxide particle may be in a range from 0.55 to 1.0.

$$phase fraction ratio = P ( LS ) / ( P ( L S ) + P ( Si ) ) \qquad [ Equation 1 ]$$

In Equation 1, P(LS) is a sum of a phase fraction of Li₂SiO₃ and a phase fraction of Li₂Si₂O₅ obtained by Rietveld Refinement using an X-ray diffraction (XRD) analysis, P(Si) is a phase fraction of silicon obtained by Rietveld Refinement using the XRD analysis.

In some embodiments, the silicon source may include a silicon particle and a SiO₂ particle.

In some embodiments, a solid content contained in the mixed solution based on a total weight of the mixed solution may be in a range from 10 wt % to 90 wt %.

In some embodiments, a solid content contained in the mixed solution based on a total weight of the mixed solution may be in a range from 30 wt % to 70 wt %.

In some embodiments, the lithium source may include LiOH, Li, LiH, Li₂O and/or Li₂CO₃.

In some embodiments, the second firing may be performed at a temperature ranging from 500° C. to 700° C.

In example embodiments, Li₂SiO₃ and/or Li₂Si₂O₅ in a lithium-silicon oxide particle may alleviate expansion of silicon, thereby improving life-span properties of a secondary battery. In example embodiments, the life-span properties may be improved while preventing reduction of an initial efficiency of the secondary battery.

In some embodiments, a size of a Li₂SiO₃ crystal phase may be relatively increased so that expansion of silicon may be sufficiently suppressed during charging and discharging of the secondary battery.

The anode active material for a lithium secondary battery and the lithium secondary battery of the present disclosure may be widely applied in green technology fields such as an electric vehicle, a battery charging station, a solar power generation, a wind power generation, etc., using a battery. The lithium secondary battery according to the present disclosure may be used for eco-friendly electric vehicles and hybrid vehicles to prevent a climate change by suppressing air pollution and greenhouse gas emission.

### BRIEF DESCRIPTION OF THE DRAWINGS

FIGS. 1 and 2 are a schematic plan view and a schematic cross-sectional view, respectively, illustrating a lithium secondary battery in accordance with example embodiments.

### DETAILED DESCRIPTION OF THE EMBODIMENTS

Embodiments of the present disclosure provide an anode active material for a lithium secondary battery (hereinafter, that may be abbreviated as an anode active material) containing a lithium-silicon oxide particle. Additionally, a lithium secondary battery (hereinafter, may be abbreviated as a secondary battery) containing the anode active material for a lithium secondary battery is provided.

Hereinafter, embodiments of the present disclosure will be described in detail. However, those skilled in the art will appreciate that such embodiments are provided to further understand the spirit of the present inventive concepts do not limit the subject matters to be protected as disclosed in the detailed description and appended claims. As used herein, the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be further understood that the singular forms “a,” “an” and “the” are intended to include the plural forms as well, unless the context clearly indicates otherwise.

In example embodiments, the cathode active material for a lithium secondary battery includes a lithium-silicon oxide particle. For example, the cathode active material may include a plurality of the lithium-silicon oxide particles.

For example, the cathode active material may further include silicon oxide (SiOx, 0<x≤2). Accordingly, both capacity and power properties may be improved.

The lithium-silicon oxide particle includes Li₂SiO₃ and silicon (Si), and may optionally further include Li₂Si₂O₅. Accordingly, Li₂SiO₃ and/or Li₂Si₂O₅ in the lithium-silicon oxide particle may alleviate expansion of silicon, thereby improving life-span properties of the secondary battery.

For example, Li₂SiO₃, Li₂Si₂O₅ and silicon may each represent different crystal phases included in the lithium-silicon oxide particle. For example, silicon may represent a separate crystal phase different from that of a silicon element contained in Li₂SiO₃ or Li₂Si₂O₅.

According to embodiments of the present disclosure, a phase fraction ratio of the lithium-silicon oxide particle defined by Equation 1 is in a range from 0.55 to 1.0.

phase fraction ratio=P(LS)/(P(LS)+P(Si)) [Equation 1]

In Equation 1, P(LS) is a sum of phase fractions of Li₂SiO₃ and Li₂Si₂O₅ each obtained by a Rietveld refinement analysis using an X-ray diffraction (XRD) analysis, and P(Si) is a phase fraction of silicon obtained by the Rietveld Refinement using the XRD analysis.

For example, in the Rietveld refinement analysis, a phase fraction and/or a lattice structure may be measured by comparing an X-ray diffraction pattern obtained by actually measuring a target material with an X-ray diffraction pattern of a sample having structural information. When the target material contains two or more crystal phases, a phase fraction of each phase can be obtained by assuming that a sum of all phase fractions is 100%.

For example, after measuring the X-ray diffraction pattern of the target material, the phase fraction and/or the lattice structure of each phase can be obtained by a comparison with a diffraction pattern of the target registered in an online database (e.g., Inorganic Crystal Structure Database (ICSD), https://icsd.products.fiz-karlsruhe.de/en/products/icsd-products).

For example, each phase fraction of Li₂SiO₃, Si and Li₂Si₂O₅ may be calculated by the Rietveld analysis, and then substituted into Equation 1 to obtain the phase fraction ratio.

For example, the phase fraction may be measured based on a reference code of Si (ICSD 98-024-6975), a reference code of Li₂SiO₃ (ICSD 98-010-0402) and a reference code of Li₂Si₂O₅ (ICSD 98-001-5414).

For example, a Si crystalline peak may correspond to at least one of about 28.2°, 47.0° and 55.7°, a Li₂SiO₃ crystalline peak may correspond to at least one of about 18.9°, 19.0°, 27.0°, 33.0° and 38.6°, and a Li₂Si₂O₅ crystalline peak may correspond to at least one of about 23.8°, 24.3°, 24.8° and 37.5°.

In the above phase fraction ratio range, a sum of crystal contents of Li₂SiO₃ and Li₂Si₂O₅ included in the lithium-silicon oxide particle may be greater than a Si crystal content. Accordingly, expansion of silicon during charging and discharging of the secondary battery may be sufficiently suppressed by Li₂SiO₃ and/or Li₂Si₂O₅. Thus, the life-span properties may be improved while preventing an initial efficiency reduction of the secondary battery.

The phase fraction ratio may have a technical meaning different from an intensity or a height of an XRD peak.

For example, the phase fraction ratio may represent an amount of each crystal present in the particle. The intensity or the height of the XRD peak may represent a size of each crystal substantially present in the particle.

For example, even when an XRD peak intensity/height of a specific crystal is greater than or equal to an XRD peak intensity/height of the other crystal, a phase fraction ratio of the specific crystal may be smaller than a phase fraction ratio of the other crystal.

For example, even when an XRD peak intensity/height of a specific crystal is equal to or less than an XRD peak intensity/height of the other crystal, a phase fraction ratio of the specific crystal may be greater than a phase fraction ratio of the other crystal.

In some embodiments, the phase fraction ratio may be in a range from 0.6 to 1.0. In the above range, the life-span properties of the secondary battery may be further improved.

In some embodiments, the crystallite size measured by the XRD analysis of Li₂SiO₃ may be 8 nm or more. In the above range, the size of the Li₂SiO₃ crystal phase may be increased to sufficiently suppress expansion of silicon during charging and discharging of the secondary battery.

In some embodiments, the crystallite size of Li₂SiO₃ may be in a range from 15 nm to 18 nm. Within the above range, the life-span properties of the secondary battery may be improved while enhancing capacity properties by silicon.

In example embodiments, the crystallite size may be measured by the XRD analysis. The crystallite size may be obtained from a Scherrer equation (Equation 2) using a full width at half maximum (FWHM) obtained through the XRD analysis.

$$L = \frac{0.9 λ}{β cos θ} \qquad [ Equation 2 ]$$

In Equation 2 above, L represents the crystal grain size (nm), λ represents an X-ray wavelength (nm), β represents a full width at half maximum (FWHM) (rad) of a peak, and θ represents a diffraction angle (rad). In example embodiments, the FWHM in the XRD analysis for measuring the crystallite size may be measured from a peak of (111) plane of Li₂SiO₃.

In some embodiments, in Equation 2 above, β may represent a FWHM obtained by correcting a value derived from an equipment. In an embodiment, Si may be used as a standard material for reflecting the equipment-derived value. In this case, the equipment-derived FWHM may be expressed as a function of 2θ by fitting a FWHM profile in an entire 2θ range of Si. Thereafter, a value obtained by subtracting and correcting the equipment-derived FWHM value at the corresponding 2θ from the function may be used as β.

In some embodiments, an average particle diameter (D50) of the lithium-silicon oxide particles may be in a range from 4 μm to 10 μm, and, in one example, may be in a range from 5 μm to 9 μm. In the above range, a BET specific surface area of the lithium-silicon oxide particles may be controlled and mechanical strength may be improved.

Accordingly, side reactions between the anode active material and an electrolyte and generation of crack in the anode active material may be suppressed.

The term “average particle diameter (D50)”, “average particle diameter,” and “D50” as used herein may be defined as a particle diameter when a cumulative volume percentage is 50% in a particle size distribution obtained based on a particle volume.

In some examples, the lithium-silicon oxide particle may further include an amorphous carbon. In an embodiment, the amorphous carbon may be coated on a surface portion of the lithium-silicon oxide particle. Accordingly, an electrical conductivity of the lithium-silicon oxide particle may be improved, and swelling phenomenon of the anode active material during charging and discharging may be suppressed.

The amorphous carbon may include, e.g., soft carbon, hard carbon, mesophase pitch oxide, pyrolyzed coke. These may be used alone or in a combination of two or more therefrom.

In some embodiments, a content of the amorphous carbon based on a total weight of the lithium-silicon oxide particle may be in a range from 1 weight percent (wt %) to 25 wt %. In an embodiment, the content of the amorphous carbon may be in a range from 2 wt % to 15 wt %, or from 3 wt % to 10 wt % by weight. In the above range, a capacity retention during repeated of charge and discharge may be further improved while sufficiently obtaining power properties from the lithium-silicon oxide particle.

According to some embodiments, the anode active material may further include a graphite-based particle including natural graphite and/or artificial graphite.

The graphite-based particle may have an amorphous shape, a plate shape, a flake shape, a spherical shape, a fibrous shape, etc.

In some examples, a content of the lithium-silicon oxide particles may be in a range from 1 wt % to 50 wt % based on a total weight of the lithium-silicon oxide particles and the graphite-based particles. In an embodiment, the content may be in a range from 5 wt % to 40 wt %, or from 10 wt % to 40 wt %. In the above range, both the capacity retention and the power properties of the lithium secondary battery may be improved together.

For example, the anode active material may include a plurality of the lithium-silicon oxide particles and a plurality of the graphite-based particles.

For example, a content of the lithium-silicon oxide particles based on a total weight of the anode active material (e.g., the total weight of a plurality of the lithium-silicon oxide particles and a plurality of the graphite-based particles) may be 1 wt % or more, 3 wt % or more, 5 wt % or more, 10 wt % or more, 15 wt % or more, 15 wt % or more, 20 wt % or more, 25 wt % or more, 30 wt % or more, 35 wt % or more, 40 wt % or more, or 45 wt % or more.

The content of the lithium-silicon oxide particles based on the total weight of the anode active material may be 99 wt % or less, 97 wt % or less, 95 wt % or less, 90 wt % or less, 85 wt % or less, 80 wt % or less, 75 wt % or less, 70 wt % or less, 65 wt % or less, 60 wt % or less, 55 wt % or less, or 50 wt % or less.

In an embodiment, the anode active material may substantially consist of the lithium-silicon oxide particles and the graphite-based particles.

Hereinafter, a method of preparing the anode active material according to example embodiments as described above will be described in more detail.

In example embodiments, silicon sources may be mixed, and a first firing may be performed to obtain silicon oxide (SiOx, 0<x≤2) particles.

For example, the silicon sources may include silicon (Si) particles and SiO₂ particles. The silicon sources may be mixed in a powder form.

For example, the first firing may be performed by heat-treating the mixed silicon sources at a temperature ranging from 500° C. to 1600° C. for 1 hour to 12 hours under an inert atmosphere and a reduced pressure condition.

In example embodiments, a mixed solution may be obtained by adding a solvent to a mixture of the prepared silicon oxide particles and a lithium source.

For example, the lithium source may include LiOH, Li, LiH, LizO, Li₂CO₃, etc. These may be used alone or in a combination of two or more therefrom.

For example, the solvent may include deionized water or an organic solvent. For example, the organic solvent may include hexane, cyclohexane, ethyl acetate, ethanol, methanol, chloroform, methyl butyl ether, ethylene glycol monobutyl ether, ethylene glycol dimethyl ether, tetrahydrofuran, etc. These may be used alone or in a combination of two or more therefrom.

In some embodiments, a solid content contained in the mixed solution may be 10 wt % to 90 wt %, and, in one embodiment, may be 30 wt % to 70 wt %, based on a total weight of the mixed solution. In the above range, the lithium source and the silicon oxide particles may be in uniform contact with each other through the solvent. Accordingly, Li₂SiO₃ and/or Li₂Si₂O₅ crystals may be sufficiently formed. Thus, the phase fraction ratio of the lithium-silicon oxide particles may be in the range of 0.55 to 1.0.

In example embodiments, the mixed solution may be dried to obtain a mixed powder.

For example, the drying may be performed by stirring the mixed solution at a temperature ranging about 40° C. to 80° C.

In example embodiments, the above-described lithium-silicon oxide particles may be formed by a second firing of the mixed powder.

For example, the formed lithium-silicon oxide particle may include Li₂SiO₃ and silicon, and may optionally further include Li₂Si₂O₅.

For example, the formed lithium-silicon oxide particles may have the phase fraction ratio defined by Equation 1 ranging from 0.55 to 1.0.

In some embodiments, the second firing may be performed under an inert atmosphere by a heat treatment at a temperature ranging from 500° C. to 1,000° C. for 1 hour to 12 hours. For example, the second firing may be performed at a temperature of 500° C. to 700° C. In the above range, damages to silicon may be prevented while sufficiently forming Li₂SiO₃ and/or Li₂Si₂O₅. Accordingly, capacity and life-span properties of the secondary battery may be improved.

In some embodiments, a ratio (Li/Si) of the number of moles of lithium elements included in the lithium source to the number of moles of silicon elements included in the silicon oxide particle may be in a range from 0.3 to 0.8. In the above range, an initial efficiency may be further improved while maintaining the capacity properties of the lithium secondary battery.

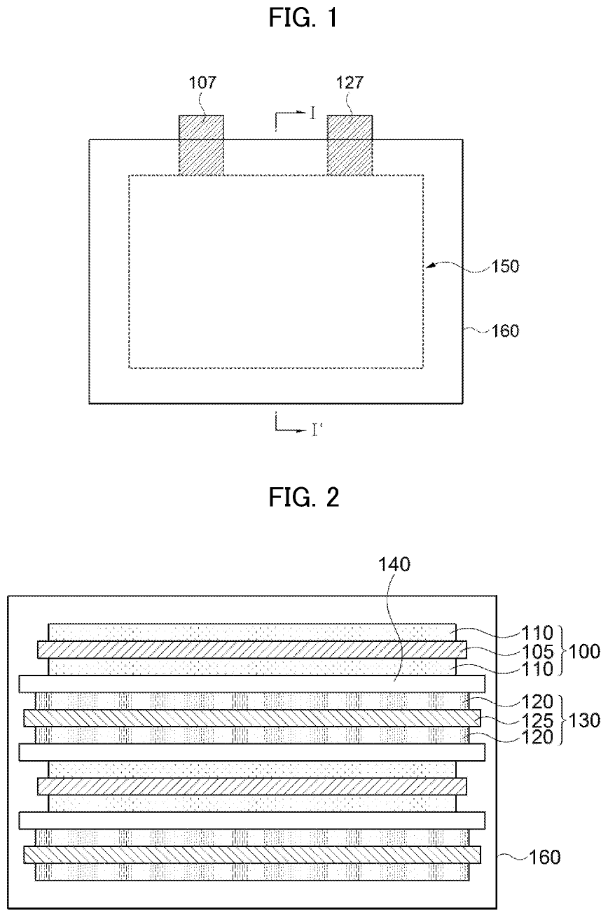

FIGS. 1 and 2 are a schematic plan view and a schematic cross-sectional view, respectively, illustrating a lithium secondary battery in accordance with example embodiments. For example, FIG. 2 is a cross-sectional view taken along a line I-I′ of FIG. 1 in a thickness direction.

Referring to FIGS. 1 and 2, the lithium secondary battery may include an anode 130 including the above-described anode active material and a cathode 100 facing the anode 130.

The cathode 100 may include a cathode current collector 105 and a cathode active material layer 110 disposed on at least one surface of the cathode current collector 105.

The cathode current collector 105 may include stainless steel, nickel, aluminum, titanium, or an alloy thereof. The cathode current collector 105 may include aluminum or stainless-steel surface-treated with carbon, nickel, titanium or silver. For example, the thickness of the cathode current collector 105 may be 10 μm to 50 μm.

The cathode active material layer 110 may include a cathode active material. The cathode active material may include a compound capable of reversibly intercalating and de-intercalating lithium ions.

The cathode active material for a lithium secondary battery according to example embodiments may include a lithium-nickel metal oxide. The lithium-nickel metal oxide may further include at least one of cobalt (Co), manganese (Mn) and aluminum (Al).

For example, the cathode active material or the lithium-nickel metal oxide may include a layered structure or a crystal structure represented by Chemical Formula 1.

LiₓNiₐM_{b}O_{2+Z} [Chemical Formula 1]

In Chemical Formula 1, 0.9≤x≤1.2, 0.6≤a≤0.99, 0.01≤b≤0.4, and −0.5≤z≤0.1. As described above, M may include Co, Mn and/or Al.

The chemical structure represented by Chemical Formula 1 indicates a bonding relationship included in the layered structure or the crystal structure of the cathode active material, and is not intended to exclude another additional element. For example, M includes Co and/or Mn, and Co and/or Mn may serve as main active elements of the cathode active material together with Ni. Chemical Formula 1 is provided to express the bonding relationship of the main active elements, and is to be understood as a formula encompassing introduction and substitution of the additional element.

In an embodiment, an auxiliary element for enhancing chemical stability of the cathode active material or the layered structure/crystal structure may be further included in addition to the main active element. The auxiliary element may be incorporated into the layered structure/crystal structure to form a bond, and it is to be understood that this case is also included within the chemical structure represented by Chemical Formula 1.

The auxiliary element may include at least one of, e.g., Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary element may act as an auxiliary active element such as Al which may contribute to capacity/power activity of the cathode active material together with Co or Mn.

For example, the cathode active material or the lithium-transition metal oxide particle may have a layered structure or a crystal structure represented by Chemical Formula 1-1 below.

LiₓNiₐM1_{b1}M2_{b2}O_{2+Z} [Chemical Formula 1-1]

In Chemical Formula 1-1, M1 may include Co, Mn and/or Al. M2 may include the above-described auxiliary element. In Chemical Formula 1-1, 0.9≤x≤1.2, 0.6≤a≤0.99, 0.01≤b1+b2≤0.4, and −0.5≤z≤0.1.

The cathode active material may further include a coating element or a doping element. For example, an element substantially the same as or similar to the above-mentioned auxiliary element may be used as the coating element or the doping element. For example, one of the above elements or a combination of two or more therefrom may be used as the coating element or the doping element.

The coating element or the doping element may be present on a surface of the lithium-nickel metal oxide particle or may penetrate through the surface of the lithium-transition metal oxide particle to be included in the bonding structure represented by Chemical Formula 1 or Chemical Formula 1-1.

The cathode active material may include a nickel-cobalt-manganese (NCM)-based lithium oxide. In this case, an NCM-based lithium oxide having an increased nickel content may be used.

Ni may serve as a transition metal related to a power and a capacity of a lithium secondary battery. Therefore, as described above, a high-Ni composition may be employed for the cathode active material, so that a high-capacity cathode and a high-capacity lithium secondary battery may be implemented.

However, as the content of Ni increases, long-term storage stability and life-span stability of the cathode or the secondary battery may be relatively deteriorated, and side reactions with an electrolyte may be also increased. However, according to example embodiments, life-span stability and capacity retention may be improved by Mn while maintaining electrical conductivity by the inclusion of Co.

A Ni content (e.g., a mole fraction of nickel among total moles of nickel, cobalt and manganese) in the NCM-based lithium oxide may be 0.6 or more, 0.7 or more, or 0.8 or more. In some embodiments, the Ni content may be from 0.8 to 0.95, from 0.82 to 0.95, from 0.83 to 0.95, from 0.84 to 0.95, from 0.85 to 0.95, or from 0.88 to 0.95.

In some embodiments, the cathode active material may include a lithium cobalt oxide-based active material, a lithium manganese oxide-based active material, a lithium nickel oxide-based active material or a lithium iron phosphate (LFP)-based active material (e.g., LiFePO₄).

In some embodiments, the cathode active material may include, e.g., a LLO (lithium layered oxide)/OLO (over lithiated oxide)-based active material, a Mn-rich-based active material, a Co-less-based active material, etc., having, e.g., a chemical structure or a crystal structure represented by Chemical Formula 2. These may be used alone or in a combination of two or more therefrom.

p[Li₂MnO₃]·(1−p)[Li_{q}JO₂] [Chemical Formula 2]

In Formula 2, 0<p<1, 0.9≤q≤1.2, and J may include at least one element of Mn, Ni, Co, Fe, Cr, V, Cu, Zn, Ti, Al, Mg and B.

A cathode slurry may be prepared by mixing the cathode active material in a solvent. The cathode slurry may be coated on at least one surface of the cathode current collector 105, and then dried and pressed to form the cathode active material layer 110. The coating may include a gravure coating, a slot die coating, a multi-layer simultaneous die coating, an imprinting, a doctor blade coating, a dip coating, a bar coating, a casting, etc. The cathode active material layer 110 may further include a binder, and may optionally further include a conductive material, a thickener, etc.

The binder may include polyvinylidene fluoride (PVDF), poly(vinylidene fluoride-co-hexafluoropropylene, polyacrylonitrile, polymethylmethacrylate, acrylonitrile butadiene rubber (NBR), polybutadiene rubber (BR), styrene-butadiene rubber (SBR), etc. These may be used alone or in a combination of two or more therefrom.

In one embodiment, a PVDF-based binder may be used as the cathode binder. In this case, an amount of the binder for forming the cathode active material layer 110 may be relatively decreased and an amount of the cathode active material may be relatively increased. Accordingly, power and capacity properties of the secondary battery may be improved.

The conductive material may be added to enhance a conductivity of the cathode active material layer 110 and/or a mobility of lithium ions or electrons. For example, the conductive material may include a carbon-based conductive material such as graphite, carbon black, acetylene black, ketjen black, graphene, carbon nanotube (CNT), vapor-grown carbon fiber (VGCF), carbon fiber, etc., and/or a metal-based conductive material including tin, tin oxide, titanium oxide, a perovskite material such as LaSrCoO₃ and LaSrMnO₃, etc. These may be used alone or in a combination of two or more therefrom.

For example, the thickener may include carboxymethyl cellulose (CMC).

The anode 130 may include an anode current collector 125 and an anode active material layer 120 formed on at least one surface of the anode current collector 125.

For example, the anode current collector 125 may include a copper foil, a nickel foil, a stainless-steel foil, a titanium foil, a nickel foam, a copper foam, a polymer substrate coated with a conductive metal, etc. These may be used alone or in a combination of two or more therefrom. For example, a thickness of the anode current collector 125 may be 10 μm to 50 μm.

The anode active material layer 120 may include the anode active material including the lithium-silicon oxide particles as described above.

An anode slurry may be prepared by mixing the anode active material in a solvent. The anode slurry may be coated/deposited on the anode current collector 105, and then dried and pressed to form the anode active material layer 120. The coating may include a gravure coating, a slot die coating, a multi-layer simultaneous die coating, an imprinting, a doctor blade coating, a dip coating, a bar coating, a casting, etc. The cathode active material layer 120 may further include a binder, and may optionally further include a conductive material, a thickener, etc.

The solvent included in the anode slurry may include water, pure water, deionized water, distilled water, ethanol, isopropanol, methanol, acetone, n-propanol, t-butanol, etc. These may be used alone or in a combination of two or more therefrom.

The above-described materials that may be used in the formation of the cathode 100 may also be used as the binder, the conductive material and the thickener.

In some embodiments, a styrene-butadiene-rubber (SBR)-based binder, carboxymethyl cellulose (CMC), a polyacrylic acid-based binder, poly(3,4-ethylenedioxythiophene) (PEDOT)-based binder, etc., may be used as the anode binder. These may be used alone or in a combination of two or more therefrom.

A separator 140 may be interposed between the cathode 100 and the anode 130. An electrical short circuit between the cathode 100 and the anode 130 may be prevented by the separator 140 while generating an ion flow. For example, a thickness of the separator may be in a range from 10 μm to 20 μm.

For example, the separator 140 may include a porous polymer film or a porous non-woven fabric.

The porous polymer film may include a polyolefin-based polymer such as an ethylene polymer, a propylene polymer, an ethylene/butene copolymer, an ethylene/hexene copolymer, an ethylene/methacrylate copolymer, etc. These may be used alone or in a combination of two or more therefrom.

The porous non-woven fabric may include a high melting point glass fiber, a polyethylene terephthalate fiber, etc.

The separator 140 may include a ceramic-based material. For example, inorganic particles may be coated on the polymer film or dispersed in the polymer film to improve a heat resistance.

The separator 140 may have a single-layered or multi-layered structure including the polymer film and/or the non-woven fabric as described above.

For example, an electrode cell may be defined by a cathode 100, an anode 130 and the separator 140, and a plurality of the electrode cells may be stacked to form an electrode assembly 150 in the form of, e.g., a jelly roll. For example, the electrode assembly 150 may be formed by winding, stacking, zigzag folding, stack-folding, etc., of the separator 140.

The electrode assembly 150 may be accommodated with an electrolyte solution in the case 160 to define a lithium secondary battery. In example embodiments, a non-aqueous electrolyte solution may be used as the electrolyte solution.

The non-aqueous electrolyte solution may include a lithium salt as an electrolyte and an organic solvent, and the lithium salt may be represented as, e.g., Li⁺X⁻. Examples of an anion X⁻ of the lithium salt include F, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

Examples of the organic solvent include propylene carbonate (PC), ethylene carbonate (EC), butylene carbonate, diethyl carbonate (DEC), dimethyl carbonate (DMC), ethylmethyl carbonate (EMC), methylpropyl carbonate, ethylpropyl carbonate, dipropyl carbonate, vinylene carbonate, methyl acetate (MA), ethyl acetate (EA), n-propylacetate (n-PA), 1,1-dimethylethyl acetate (DMEA), methyl propionate (MP), ethylpropionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), tetrahydrofuran (THF), 2-methyltetrahydrofuran, ethyl alcohol, isopropyl alcohol, dimethyl sulfoxide, acetonitrile, dimethoxyethane, diethoxyethane, sulfolane, gamma-butyrolactone, propylene sulfite, etc. These may be used alone or in a combination of two or more therefrom.

The non-aqueous electrolyte solution may further include an additive. The additive may include, e.g., a cyclic carbonate-based compound, a fluorine-substituted carbonate-based compound, a sultone-based compound, a cyclic sulfate-based compound, a cyclic sulfite-based compound, a phosphate-based compound, a borate-based compound, etc. These may be used alone or in a combination of two or more therefrom.

The cyclic carbonate-based compound may include vinylene carbonate (VC), vinyl ethylene carbonate (VEC), etc.

The fluorine-substituted cyclic carbonate-based compound may include fluoroethylene carbonate (FEC).

The sultone-based compound may include 1,3-propane sultone, 1,3-propene sultone, 1,4-butane sultone, etc.

The cyclic sulfate-based compound may include 1,2-ethylene sulfate, 1,2-propylene sulfate, etc.

The cyclic sulfite-based compound may include ethylene sulfite, butylene sulfite, etc.

The phosphate-based compound may include lithium difluoro bis-oxalato phosphate, lithium difluoro phosphate, etc.

The borate-based compound may include lithium bis(oxalate) borate.

In some embodiments, a solid electrolyte may be used instead of the non-aqueous electrolyte solution. In this case, the lithium secondary battery may be manufactured in the form of an all-solid-state battery. Additionally, a solid electrolyte layer may be disposed between the cathode 100 and the anode 130 instead of the separator 140.

The solid electrolyte may include a sulfide-based electrolyte. Non-limiting examples of the sulfide-based electrolyte include Li₂S—P₂S₅, Li₂S—P₂S₅—LiCl, Li₂S—P₂S₅—LiBr, Li₂S—P₂S₅—LiCl—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZmSn (m and n are positive numbers, and Z represents Ge, Zn or Ga), Li₂S—GeS₂, Li₂S—SiS₂—Li₃PO₄, Li₂S—SiS₂—LipMOq, (p and q positive numbers, and M represents P, Si, Ge, B, Al, Ga or In), Li₇-xPS₆-xClₓ (0≤x≤2), Li₇-xPS₆-XBrₓ (0≤x≤2), Li₇-xPS₆-xIₓ (0≤x≤2), etc. These may be used alone or in combination of two or more therefrom.

In one embodiment, the solid electrolyte may include an oxide-based amorphous solid electrolyte such as Li₂O—B₂O₃—P₂O₅, Li₂O—SiO₂, Li₂O—B₂O₃, Li₂O—B₂O₃—ZnO, etc.

As illustrated in FIGS. 1 and 2, electrode tabs (a cathode tab and an anode tab) may protrude from the cathode current collector 105 and the anode electrode current collector 125 included in each electrode cell to one side of the case 160. The electrode tabs may be welded together with the one side of the case 160 to form an electrode lead (a cathode lead 107 and an anode lead 127) extending or exposed to an outside of the case 160.

The lithium secondary battery may be manufactured in, e.g., a cylindrical shape using a can, a prismatic shape, a pouch shape or a coin shape.

Hereinafter, experimental examples are proposed to more concretely describe embodiments of the present disclosure. However, the following examples are only given for illustrating the present disclosure and those skilled in the related art will obviously understand that various alterations and modifications are possible within the scope and spirit of the present disclosure. Such alterations and modifications are duly included in the appended claims.

### Example 1

### Preparation of Lithium-Silicon Oxide Particles

A raw material formed by mixing a Si powder and an SiO₂ powder in a weight ratio of 1:1 was added to a reactor, and a first firing was performed at a reduced pressure of 10 Pa and a temperature of 600° C. for 5 hours to obtain a mixture.

The obtained mixture was deposited on an adsorption plate and sufficiently cooled, and then a deposited material was collected. The deposited material was pulverized with a ball mill to prepare silicon oxide particles in the form of SiO. The prepared silicon oxide particles were classified so that an average particle diameter (D50) was 6 μm.

A mixture was formed by mixing the silicon oxide particles and a LiOH powder to have a Li/Si mole ratio of 0.70 under an argon (Ar) gas atmosphere. A hexane solvent was added to the mixture to form a mixed solution. The hexane solvent was added such that a solid content based on a total weight of the mixed solution was 30 wt %. The mixed solution was stirred at 60° C. for 12 hours and dried to obtain a mixed powder. The mixed powder was put in an alumina crucible.

A second firing to the alumina crucible was performed at 600° C. for 8 hours under an argon gas atmosphere, and then pulverized to prepare lithium-silicon oxide particles. The average particle diameter (D50) of the lithium-silicon oxide particles was 6.7 μm.

The lithium-silicon oxide particles were stirred in a 0.5 M aqueous acetic acid solution for 30 minutes and filtered to remove unreacted residual lithium.

### Fabrication of Anode

90 wt % of the lithium-silicon oxide particles, 3 wt % of styrene-butadiene rubber (SBR) as a binder, 2 wt % of carbon black (Super C) as a conductive material, and 5 wt % of carboxymethyl cellulose (CMC) as a thickener were mixed to form an anode slurry.

The anode slurry was coated on a copper substrate, dried and pressed to obtain an anode.

### Fabrication of Lithium Half Cell (Li-Half Cell)

A lithium half-cell including the above-prepared anode and using a lithium metal as a counter electrode (cathode) was manufactured.

Specifically, a separator (polyethylene, thickness of 20 μm) was interposed between the anode and the lithium metal (thickness of 1 mm) to form a lithium coin half-cell.

The assembly of the lithium metal/separator/anode was put into a coin cell plate, an electrolyte was injected, the cap was covered, and then clamped. A 1.0 M LiPF₆ solution was prepared using a mixed solvent of EC/EMC (3:7 volume ratio), and then 2 vol % of fluoroethylene carbonate (FEC) based on a total volume of the electrolyte was added to prepare the electrolyte. After clamping, impregnation proceeded for 3 hours to 24 hours, and three cycles of charge and discharge were performed at 0.1C (charging condition CC-CV 0.1V 0.01V CUT-OFF, discharging condition CC 0.1C 1.5V CUT-OFF).

### Examples 2 to 7, and Comparative Examples 1 and 2

Lithium-silicon oxide particles, an anode and a lithium half-cell were prepared by the same methods as those in Example 1, except that the temperature of the second firing, the solid content based on the total weight of the mixed solution, the sum of the phase fractions of Li₂SiO₃ and Li₂Si₂O₅ included in the lithium-silicon oxide particles, the phase fraction of Si, the phase fraction ratio defined by Equation 1, and the crystallite size of Li₂SiO₃ were adjusted as described in Table 2.

### Example 8

Lithium-silicon oxide particles, an anode and a lithium half-cell were prepared by the same method as those in Example 1, except that 10 wt % of soft carbon was added to prepare lithium-silicon oxide particles coated with an amorphous carbon.

### Experimental Example

### (1) Measurement of Phase Fraction Ratio

The lithium-silicon oxide particles prepared according to Examples and Comparative Examples were subjected to a Rietveld analysis using an XRD analysis to measure a phase fraction of Li₂SiO₃, a phase fraction of Li₂Si₂O₅ and a phase fraction of Si.

Specifically, X-ray diffraction patterns were measured by performing the XRD analysis on the lithium-silicon oxide particles prepared according to Examples and Comparative Examples.

Data on the Li₂Si₂O₅ phase, the Li₂SiO₃ phase and the Si phase from the measured X-ray diffraction patterns were compared with X-ray diffraction patterns of reference codes of Li₂SiO₃, Li₂Si₂O₅ and Si (Inorganic Crystal Structure Database (ICSD) 98-010-0402, ICSD 98-001-5414 and ICSD 98-024-6975) registered in online-database (ICSD, https://icsd.products.fiz-karlsruhe.de/en/products/icsd-products) to obtain each phase fraction of Li₂SiO₃, Li₂Si₂O₅ and Si.

The phase fraction ratio was calculated by substituting the obtained a sum of the phase fractions of Li₂SiO₃ and Li₂Si₂O₅, and the phase fraction of Si into Equation 1.

Specific XRD analysis equipment/conditions are as listed in Table 1 below.

TABLE 1
XRD(X-Ray Diffractometer)

| Maker | PANalytical | |
|---|---|---|
| Model | EMPYREAN | |
| Anode material | Cu | |
| K-Alpha1 wavelength | 1.540598 | Å |
| Generator voltage | 45 | kV |
| Tube current | 40 | mA |

| | |
|---|---|
| Scan Range | 10~70° |
| Scan Step Size | 0.0065° |
| Divergence slit | ¼° |
| Antiscatter slit | 1° |

(2) Measurement of Crystallite Size of Li₂SiO₃

The lithium-silicon oxide particles prepared according to the above-described Examples and Comparative Examples were subjected to an XRD analysis and each crystallite size was calculated using Equation 2.

Specific XRD analysis equipment/conditions are as described in Table 1 above.

### (3) Detection of Amorphous Carbon Coating

An elemental analyzer (EA) analysis was performed on lithium-silicon oxide particles prepared according to Examples and Comparative Examples to evaluate whether the amorphous carbon was coated. Specifically, detection of carbon elements were determined from the lithium-silicon oxide particles as follows.

O: Amorphous carbon was included

X: Amorphous Carbon was not included.

Table 2 shows the measurement results of Experimental Examples (1) to (3).

TABLE 2

| | | | sum of | | | | |
|---|---|---|---|---|---|---|---|
| | | | phase | | | | |
| | second | | fractions of | phase | | | |
| | firing | solid | Li₂SiO₃ and | fraction | phase | Li₂SiO₃ | amorphous |
| | temperature | content | Li₂Si₂O₅ | of Si | fraction | crystallite | carbon |
| | (° C.) | (wt %) | (%) | (%) | ratio | size (nm) | coating |
| Example 1 | 600 | 30 | 66 | 34 | 0.66 | 18 | X |
| Example 2 | 600 | 50 | 60 | 40 | 0.60 | 15 | X |
| Example 3 | 600 | 70 | 55 | 45 | 0.55 | 16 | X |
| Example 4 | 550 | 30 | 65 | 35 | 0.65 | 9 | X |
| Example 5 | 550 | 50 | 58 | 42 | 0.58 | 7 | X |
| Example 6 | 550 | 70 | 56 | 44 | 0.56 | 6 | X |
| Example 7 | 480 | 30 | 55 | 45 | 0.55 | 5 | X |
| Example 8 | 600 | 30 | 64 | 36 | 0.64 | 15 | ◯ |
| Comparative | 600 | 100 | 50 | 50 | 0.50 | 14 | X |
| Example 1 | | | | | | | |
| Comparative | 550 | 100 | 51 | 49 | 0.51 | 5 | X |
| Example 2 | | | | | | | |

### (4) Evaluation on Initial Discharge Capacity and Initial Capacity Efficiency

Charging (CC-CV 0.1C 0.01V CUT-OFF) and discharging (CC 0.1C 1.5V CUT-OFF) were performed once at room temperature (25° C.) for the lithium half-battery prepared according to each of Examples and Comparative Examples to measure an initial charging capacity and an initial discharging capacity.

The initial discharge capacity was divided by the initial charging capacity to evaluate an initial capacity efficiency as a percentage.

### (5) Evaluation on Capacity Retention (50 Cycles)

For the lithium half-cells prepared according to the above-described Examples and Comparative Examples, charging (CC-CV 0.1C 0.01V CUT-OFF) and discharging (CC 0.1C 1.5V CUT-OFF) were performed by 50 cycles at room temperature (25° C.) to measure a discharge capacity. A 10-minute interphase was present between the cycles. The measured discharge capacity was divided by the initial discharge capacity measured in the above (4) to calculate a capacity retention as a percentage.

The evaluation results of Experimental Examples (4) and (5) are shown in Table 3 below.

TABLE 3

| | initial discharge | initial capacity | capacity retention |
|---|---|---|---|
| | capacity (mAh/g) | efficiency (%) | (50 cycles) (%) |
| Example 1 | 1332 | 90.5 | 91.5 |
| Example 2 | 1340 | 89.9 | 91.2 |
| Example 3 | 1354 | 89.5 | 90.6 |
| Example 4 | 1363 | 85.4 | 90.4 |
| Example 5 | 1364 | 86.5 | 88.9 |
| Example 6 | 1370 | 86.2 | 88.7 |
| Example 7 | 1345 | 88.0 | 88.5 |
| Example 8 | 1336 | 91.1 | 91.4 |
| Comparative | 1355 | 89.0 | 80.6 |
| Example 1 | | | |
| Comparative | 1371 | 85.0 | 81.2 |
| Example 2 | | | |

Referring to Table 2 and Table 3, in Examples where the phase fraction ratio of the lithium-silicon oxide particles was in a range from 0.55 to 1.0, the initial capacity efficiency and the capacity retention were generally improved compared to those from Comparative Examples.

In Examples 5 and 6 where the crystallite size of Li₂SiO₃ was less than 8 nm, and the initial capacity efficiency and the capacity retention were relatively lowered compared to those from other Examples.

In Example 7, the second firing was performed at a temperature less than 500° C. to reduce the growth of the Li₂SiO₃ crystal phase and the Li₂Si₂O₅ crystal phase, and the initial capacity efficiency and the capacity retention were relatively lowered compared to those from other Examples.

What is claimed is:

1. An anode active material for a lithium secondary battery comprising a lithium-silicon oxide particle that includes Li₂SiO₃ and silicon, and optionally further includes Li₂Si₂O₅,
wherein a phase fraction ratio defined by Equation 1 of the lithium-silicon oxide particle is in a range from 0.55 to 1.0:
$$phase fraction ratio = P ( LS ) / ( P ( L S ) + P ( Si ) ) \qquad [ Equation 1 ]$$
wherein, in Equation 1, P(LS) is a sum of a phase fraction of Li₂SiO₃ and a phase fraction of Li₂Si₂O₅ obtained by Rietveld Refinement using an X-ray diffraction (XRD) analysis, P(Si) is a phase fraction of silicon obtained by Rietveld Refinement using the XRD analysis.

2. The anode active material for a lithium secondary battery according to claim 1, wherein a crystallite size measured by the XRD analysis of Li₂SiO₃ is 8 nm or more.

3. The anode active material for a lithium secondary battery according to claim 2, wherein the crystallite size of Li₂SiO₃ is obtained from Equation 2:
$$L = \frac{0.9 λ}{β cos θ} \qquad [ Equation 2 ]$$
wherein, in Equation 2, L is the crystallite size (nm), à is an X-ray wavelength (nm), β is a full width at half maximum (rad) of a peak of a (111) plane of Li₂SiO₃, and θ is a diffraction angle (rad).

4. The anode active material for a lithium secondary battery according to claim 2, wherein the crystallite size of Li₂SiO₃ is in a range from 15 nm to 18 nm.

5. The anode active material for a lithium secondary battery according to claim 1, wherein the phase fraction ratio is in a range from 0.6 to 1.0.

6. The anode active material for a lithium secondary battery according to claim 1, wherein the lithium-silicon oxide particle further includes an amorphous carbon.

7. The anode active material for a lithium secondary battery according to claim 1, further comprising a graphite-based particle that includes at least one selected from the group consisting of natural graphite and artificial graphite.

8. A lithium secondary battery, comprising:
a cathode; and
an anode facing the cathode and including the anode active material for a lithium secondary battery of claim 1.

9. A method of preparing an anode active material for a lithium secondary battery, comprising:
performing a first firing of silicon sources to obtain a silicon oxide particle;
obtaining a mixed solution by adding a solvent to a mixture of the silicon oxide particle and a lithium source;
drying the mixed solution to obtain a mixed powder; and
performing a second firing of the mixed powder to form a lithium-silicon oxide particle that includes Li₂SiO₃ and silicon and optionally further includes Li₂Si₂O₅, and
wherein a phase fraction ratio defined by Equation 1 of the lithium-silicon oxide particle is in a range from 0.55 to 1.0:
$$phase fraction ratio = P ( LS ) / ( P ( L S ) + P ( Si ) ) \qquad [ Equation 1 ]$$
wherein, in Equation 1, P(LS) is a sum of a phase fraction of Li₂SiO₃ and a phase fraction of Li₂Si₂O₅ obtained by Rietveld Refinement using an X-ray diffraction (XRD) analysis, P(Si) is a phase fraction of silicon obtained by Rietveld Refinement using the XRD analysis.

10. The method of claim 9, wherein the silicon source includes a silicon particle and a SiO₂ particle.

11. The method of claim 9, wherein a solid content contained in the mixed solution based on a total weight of the mixed solution is in a range from 10 wt % to 90 wt %.

12. The method of claim 9, wherein a solid content contained in the mixed solution based on a total weight of the mixed solution is in a range from 30 wt % to 70 wt %.

13. The method of claim 9, wherein the lithium source includes at least one selected from the group consisting of LiOH, Li, LiH, Li₂O and Li₂CO₃.

14. The method of claim 9, wherein the second firing is performed at a temperature ranging from 500° C. to 700° C.
